(19) United States
(12) Patent Application Publication
(10) Pub. No.: US 2018/0016919 A1
(43) Pub. Date: Jan. 18, 2018

(54) THERMAL BARRIER COATINGS WITH ENHANCED REFLECTIVITY

(71) Applicant: Delavan Inc, West Des Moines, IA (US)

(72) Inventors: Alexander Staroselsky, Avon, CT (US); Thomas J. Martin, East Hampton, CT (US)

(21) Appl. No.: 15/208,066

(22) Filed: Jul. 12, 2016

(51) Int. Cl. F01D 5/28; B05D 7/24; C23C 4/12

(52) U.S. Cl. CPC F01D 5/288; C23C 4/12; B05D 7/24; F05D 2300/2118; F05D 2300/21; F05D 2240/30; F05D 2230/90; F05D 2220/323; F05D 2300/504; F05D 2300/611; F05D 2300/17

(57) ABSTRACT

A structure includes a substrate, and a thermal barrier coating comprising a base material and one or more reflective layers disposed in the base material, each reflective layer having a plurality of reflective particulates. The structure can be a turbine blade, for example.

### BACKGROUND

### 1. Field

The present disclosure relates to thermal barrier coatings, more specifically to thermal barrier coatings for high temperature components (e.g., for turbine blades of a turbomachine)

### 2. Description of Related Art

In modern turbomachines, which comprise turbofans, turbojets, gas turbine engines, and the like, the purpose of the turbine component is to extract work from the high pressure and high temperature core flow. The two most important parameters that determine the turbine's power output and fuel efficiency are the rotor speed and combustion temperature. Increases in the rotor speed and combustion temperature offer the greatest improvements to the fuel efficiency and power output of the engine. It is well understood that the turbine rotor speed determines the maximum pressure ratios that can be obtained by the turbine, and increasing the speed, temperature and cross-sectional area of the core flow increases the amount of energy that can be extracted as work to drive the fan and compressor. As a consequence, hot section components, such as combustor liners, turbine airfoils, and air seals, are subjected to the highest possible temperatures, which result in increased risk of structural failure, and accelerated material deterioration and degradation due to creep, oxidation, corrosion and thermo-mechanical fatigue at high temperature.

Thermal barrier coatings (TBC), shield the hot section components from the high temperature external gases, providing up to 400 degrees C. protection, which allows the turbine components to be fully operable and durable at higher temperatures, providing greater power and fuel efficiency. The structural performance and life capabilities of hot section components rely on this TBC property. The current TBC material for gas turbine hot section components is yttria partially stabilized zirconia (YPSZ or YSZ). Zirconia (ZrO2) has good erosion resistance, a lower intrinsic thermal conductivity and most suitable thermal expansion coefficient as compared to other ceramics such as alumina (Al2O3). Yttria (Y2O3) is added into pure zirconia to stabilize the cubic or tetragonal structure and further reduce the thermal conductivity. In addition to the chemical composition, the method of processing and structure of the coating has a significant impact on the thermal and mechanical properties of the coating. However, the capability of these zirconia based materials is still limited. Zirconia-based TBCs are only partially transparent to infrared (thermal) radiation.

Increase of the combustion gas temperature causes significant increase of the amount of heat transferred from the gas via infrared radiation, because it is proportional to the temperature in the fourth power. The absorbance of zirconia-based thermal barrier coatings to infrared radiation reduces dramatically with wavelengths shorter than 8 μm, and becoming almost fully transparent below 4 μm. The reflectance of TBCs in the IR range of 1 to 4 μm is also low (about 0.2) for single crystal (EB-PVD) TBCs, but better for thermal spray TBCs (0.5) due to increased scattering, which increases with increasing temperature. Therefore, zirconia-based TBCs provide only poor protection to surfaces exposed to the intense thermal radiation of the combustion in the engine. This is made worse by the fact that the peak blackbody radiation intensity is around 2.5 μm at convectional engine operating temperatures, making YSZ TBC protection versus thermal radiation lesser with increasing engine operating temperatures.

Such conventional thermal protection systems have generally been considered satisfactory for their intended purpose. However, there is still a need in the art for improved thermal barrier coatings. The present disclosure provides a solution for this need.

### SUMMARY

A structure includes a substrate and a thermal barrier coating disposed on the substrate comprising a base material and one or more reflective layers disposed in the base material, each reflective layer having a plurality of reflective particulates. The structure can be a turbine blade, and the base material of the thermal barrier coating can be yttria-stabilized zirconia, for example.

The substrate can include a nickel alloy. Any other suitable material is contemplated herein for the substrate. The base material can include a ceramic material (e.g., that inherently has a low absorbance and reflectance of infrared radiation). Any other suitable material is contemplated herein.

The reflective particulates can include a material that reflects infrared radiation (e.g., including wavelengths below about 8 microns, wavelengths less than 4 microns). Any suitable material for the particulates is contemplated herein (e.g., such that the reflective particulates reflect thermal radiation to a greater extent than the base material in at least a certain range of wavelengths). For example, the reflective particulates can include TiO₂ particulates which have increased reflectance in the short and mid infrared wavelengths.

The reflective particulates can include at least one of a spherical shape, a conical shape, an elliptical shape, a spheroid shape, or a fiber.

A volume fraction of the reflective particulates can be a small fraction of total volume of the thermal barrier coating and reflective particles can be substantially smaller than the thickness of the thermal barrier coating, for example. In certain embodiments, a volume fraction of the reflective particulates can be about 2% to about 5% of total volume of the thermal barrier coating, and include reflective particulates that are less than about 4 microns in diameter and in length.

The one or more reflective layers can include a plurality of reflective layers, each reflective layer separated by about 1 to about 3 lengths of the reflective particulates. Any other suitable separation is contemplated herein.

In certain embodiments, the one or more reflective layers can be located no deeper than about 25% of a thickness of the thermal barrier coating from a surface of the thermal barrier coating. A distribution density of reflective particulates in the base material can be selected to maximize reflectivity without compromising thermal conductivity or structural stability of the thermal barrier coating.

In accordance with at least one aspect of this disclosure, a method for creating a thermal barrier coating applying a base material to a substrate and disposing one or more reflective layers having a plurality of reflective particulates within the base material. Applying the base material can include thermal spraying or cold spraying the substrate with the base material.

Disposing one or more reflective layers can include thermal spraying or cold spraying the base material with reflective particulates. Applying and disposing can be at least partially simultaneously performed by spraying the substrate or the base material with a slurry including the base material and the reflective particulates.

These and other features of the systems and methods of the subject disclosure will become more readily apparent to those skilled in the art from the following detailed description taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a partial cross-sectional view of an embodiment of a structure in accordance with this disclosure; and

FIG. 2 is a partial perspective view of an embodiment of a thermal barrier coating in accordance with this disclosure.

### DETAILED DESCRIPTION

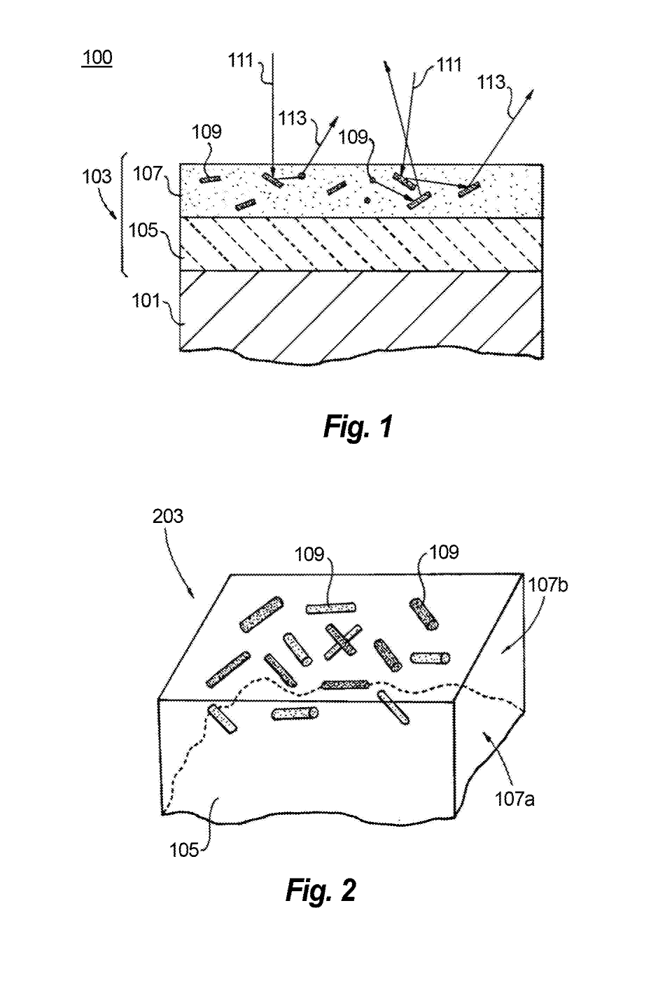

Reference will now be made to the drawings wherein like reference numerals identify similar structural features or aspects of the subject disclosure. For purposes of explanation and illustration, and not limitation, an illustrative view of an embodiment of a structure in accordance with the disclosure is shown in FIG. 1 and is designated generally by reference character 100. Other embodiments and/or aspects of this disclosure are shown in FIG. 2. The systems and methods described herein can be used to improve the usable life of structures (e.g., turbine blades) exposed to high heat environments (e.g., in turbomachines), for example.

Referring to FIG. 1, a structure 100 includes a substrate 101 and a thermal barrier coating 103. The thermal barrier coating 103 includes a base material 105 and one or more reflective layers 107 disposed in the base material 103. Each reflective layer can have a plurality of reflective particulates 109 (e.g., infrared reflective particles).

The structure 100 can be a turbine blade (e.g., for a turbomachine), for example. Any other suitable structure (e.g., for use in a high temperature environment) is contemplated herein.

The substrate 101 can include a nickel alloy. Any other suitable material is contemplated herein for the substrate 101. The base material 105 can include a ceramic material (e.g., yttria partially stabilized zirconia). Any other suitable material is contemplated herein.

The reflective particulates 109 can include a material that reflects wavelengths in the short and mid wavelength infrared spectrum. For example, the reflective particulates can reflect wavelengths below about 8 microns (e.g., less than 4 microns), such as, for example. Any other suitable reflectivity is contemplated herein (e.g., long wave infrared).

The reflective particulates can be configured to reflect thermal radiation to a greater extent than the base material in at least a certain range of wavelengths. For example, the reflective particulates can include TiO₂ particulates which have increased reflectance in the short and mid infrared wavelengths over yttria partially stabilized zirconia. Any other suitable material is contemplated herein.

The reflective particulates 109 can include at least one of a spherical shape, a conical shape, an elliptical shape, a spheroid shape, or a fiber, rhombohedral, for example. The reflectivity can change and/or be selected based on the particle shape. For example, there exists in general such a relation of scattering cross sections: C sphere<Cneedle<Cdisc. Moreover, the reflective particulates can be sized to include suitable electromagnetic properties to reflect energy of a desired wavelength or range of wavelengths (e.g., having a diameter less than one-half the wavelength of light to be scattered, such as a diameter of about 0.5 microns to about 4 microns). Any suitable shape and/or size of the reflective particulates 109 and/or combinations thereof in a single or multiple layers 107 is contemplated herein.

A volume fraction of the reflective particulates 109 can be about 2% to about 5% of total volume of the thermal barrier coating 103 depending on their scattering efficiency . . . . For example, a volume fraction of spherical reflective particulates 109 of about 2.75% with rhombohedral arrangement of the reflective particulates can provide about 50% scattering efficiency. The reflective particulates 109 having a fiber shape may demonstrate better performance.

Referring additionally to FIG. 2, the one or more reflective layers 107 can include a plurality of reflective layers 107 (e.g., a first layer 107a disposed under a second layer 107b in thermal barrier coating 203). Each layer 107a, 107b can include any suitable reflective particulates 109 (e.g., of different shape, of the same shape, or of any suitable combination of shapes). Each reflective layer 107 can be separated by about 1 to about 3 lengths of the reflective particulates 109. Any other suitable separation is contemplated herein.

In certain embodiments, the one or more reflective layers 107 can be located no deeper than about 25% (e.g., less than 5%) of a thickness of the thermal barrier coating 103 from a surface of the thermal barrier coating 105. In this regard, the reflective particulates 109 can be localized near the surface of the thermal barrier coating 103. Any other suitable depth for reflective particulates 109 is contemplated herein.

A distribution density of reflective particulates 109 in the base material 105 can be selected to maximize reflectivity without compromising thermal conductivity or structural stability of the thermal barrier coating 103, for example. Embedded reflective particulates (e.g., fibers) can be disposed to generate an irregular grid submerged in the infrared transparent matrix of the base material 105 that generates the composite structure which effectively reflects the incident light 111. Any other suitable distribution density and/or pattern thereof is contemplated herein.

In accordance with at least one aspect of this disclosure, a method for creating a thermal barrier coating 103 applying a base material to a substrate 101 and disposing one or more reflective layers 107 having a plurality of reflective particulates 109 within the base material 105. Applying the base material 105 can include thermal spraying or cold spraying the substrate 101 with the base material 105.

Disposing one or more reflective layers 107 can include thermal spraying or cold spraying the base material 105 with reflective particulates 109. Applying and disposing can be at least partially simultaneously performed by spraying the substrate 101 or the base material 105 with a slurry that has both the base material 105 and the reflective particulates 109, for example. While described as layers 107 above, demarcation is not necessary because the thermal barrier coating can be continuous such that particulates 109 are disposed within continuously formed base material 105 during formation of the thermal barrier coating.

As described above, in order to reflect a targeted range of wavelengths, layers of ceramic materials with low and high refractive indices can be added without deteriorating the thermal barrier coating structural properties. A broadband reflection of the infrared (e.g., low and/or medium wave) wavelengths can be achieved by the selection of the corresponding size of the reflecting elements. Infrared reflection can reduce the temperature up to 160 degrees F. (90 degrees C.) on the metal interface surface between the substrate 101 and the thermal barrier coating 103 that eventually leads to up to a fivefold lifetime increase for turbine blades, for example.

In the layers 107 having high refractive index particles, infrared light is bent with the result that light travels a shorter path in the coating and does not penetrate through it causing practically all incident light 111 to be returned to the surface as reflected light 113. Effective scattering can be achieved if the particles diameter is slightly less than one-half the wavelength of light to be scattered, for example.

Certain embodiments utilize the reflective properties of TiO₂ fibers and/or particles together with their thermal and oxidation stability. TiO₂ fibers, for example, can impart structural enhancements to the ceramic thermal barrier coating exhibiting a structure similar to ferro-concrete. The fibers can enhance the material's toughness while maintaining or even enhancing its thermal and environmental insulating properties. For example, the reinforced composite material has been found to have up to 5 times the fracture toughness over monolithic ceramic materials fabricated with the same process, especially when the material is subject to cyclic loadings.

Embodiments provide the ability of a thermal barrier coating that effectively reflects thermal radiation over a wide spectral range which can significantly improve the efficiency of thermal barrier coatings. For turbomachine parts, improved reflectance leads to extension of part life and to the increase of overall turbine efficiency, for example. Current methods to increase hot section parts durability only address the convective portion of the heat load. Further, at higher temperature, a great portion of the heat transferred to the part has radiative nature and not convective heat. Existing thermal barrier coatings only address the convective portion of the heat load because they are almost transparent to the radiative portion at the wavelength of peak flux.

The methods and systems of the present disclosure, as described above and shown in the drawings, provide for thermal barrier coatings with superior properties including improved reflectance. While the apparatus and methods of the subject disclosure have been shown and described with reference to embodiments, those skilled in the art will readily appreciate that changes and/or modifications may be made thereto without departing from the spirit and scope of the subject disclosure.

What is claimed is:

1. A structure, comprising:
a substrate; and
a thermal barrier coating disposed on the substrate comprising a base material and one or more reflective layers disposed in the base material, each reflective layer having a plurality of reflective particulates.

2. The structure of claim 1, wherein the substrate includes a metal alloy.

3. The structure of claim 1, wherein the base material includes a ceramic material.

4. The structure of claim 1, wherein the reflective particulates include a material that reflects wavelengths below about 8 microns.

5. The structure of claim 4, wherein the reflective particulates include TiO₂ particulates.

6. The structure of claim 1, wherein the reflective particulates include at least one of a spherical shape, a conical shape, an elliptical shape, a spheroid shape, or a fiber.

7. The structure of claim 1, the base material of the thermal barrier coating can be yttria-stabilized zirconia.

8. The structure of claim 1, wherein a volume fraction of the reflective particulates is about 2% to about 5% of total volume of the thermal barrier coating.

9. The structure of claim 1, wherein the one or more reflective layers includes a plurality of reflective layers, each reflective layer separated by about 1 to about 3 lengths of the reflective particulates.

10. The structure of claim 1, wherein a distribution density of reflective particulates in the base material can be selected to maximize reflectivity without compromising thermal conductivity or structural stability of the thermal barrier coating.

11. The structure of claim 1, wherein the one or more reflective layers are located no deeper than about 25% of a thickness of the thermal barrier coating from a surface of the thermal barrier coating.

12. The structure of claim 1, wherein the structure is a turbine blade.

13. A method for creating a thermal barrier coating, comprising:
applying a base material to a substrate; and
disposing one or more reflective layers having a plurality of reflective particulates within the base material.

14. The method of claim 13, wherein applying the base material includes thermal spraying or cold spraying the substrate with the base material.

15. The method of claim 13, wherein disposing one or more reflective layers includes thermal spraying or cold spraying the base material with reflective particulates.

16. The method of claim 13, wherein applying and disposing are at least partially simultaneously performed by spraying the substrate or the base material with a slurry including the base material and the reflective particulates.
